(19) United States
(12) Patent Application Publication
(10) Pub. No.: US 2026/0312763 A1
(43) Pub. Date: Oct. 8, 2026

(54) PUSCH Antenna Port Indication Enhancement for DMRS Type 2

(71) Applicant: Apple Inc., Cupertino, CA (US)

(72) Inventors: Haitong SUN, Saratoga, CA (US); Ankit BHAMRI, Haar (DE); Dawei ZHANG, Saratoga, CA (US); Jie CUI, San Jose, CA (US); Manasa RAGHAVAN, Sunnyvale, CA (US); Oghenekome OTERI, San Diego, CA (US); Wei ZENG, Saratoga, CA (US)

(21) Appl. No.: 19/483,425

(22) PCT Filed: May 10, 2024
(86) PCT No.: PCT/US2024/028860

§ 371 Date: Nov. 11, 2025

Related U.S. Application Data
(60) Provisional application No. 63/501,439, filed on May 11, 2023.

(51) Int. Cl. H04L 5/00; H04J 13/16; H04W 72/563

(52) U.S. Cl. CPC H04L 5/0051; H04J 13/16; H04W 72/563

(57) ABSTRACT

An apparatus comprising configured to process, based on signals received from a network, a plurality of tables, wherein each table comprises one or more entries related to a selection of demodulation reference signal (DMRS) ports for a Physical Uplink Shared Channel (PUSCH), process, based on signals received from the network, a DMRS type 2 configuration for the PUSCH, select an entry from one of the plurality of tables based on the DMRS configuration and generate, for transmission, the PUSCH comprising DMRS type 2 on the DMRS ports corresponding to the entry, wherein the DMRS ports are at least one of (i) legacy ports or (ii) enhanced ports.

### PRIORITY/INCORPORATION BY REFERENCE

This application claims priority to U.S. Provisional Application Serial No. 63/501,439 entitled “PUSCH Antenna Port Indication Enhancement for DMRS Type 2,” filed on May 11, 2023, the entirety of which is incorporated by reference herein.

### BACKGROUND

In a new radio (NR) network, several different reference signals (RSs) are used to increase protocol efficiency. These RSs may be transmitted by a base station and received by a user equipment (UE) in the downlink (DL) or transmitted by a UE and received by a base station in the uplink (UL). One of these reference signals is referred to as a Demodulation Reference Signal (DMRS) and may be used in the DL or UL physical channels for channel estimation and/or coherent demodulation. The DMRS is used by the receiving device (e.g., UE or base station) to estimate the demodulation associated with a physical radio channel.

### SUMMARY

Some example embodiments are related to an apparatus having processing circuitry configured to process, based on signals received from a network, a plurality of tables, wherein each table comprises one or more entries related to a selection of demodulation reference signal (DMRS) ports for a Physical Uplink Shared Channel (PUSCH), process, based on signals received from the network, a DMRS type 2 configuration for the PUSCH, select an entry from one of the plurality of tables based on the DMRS configuration and generate, for transmission, the PUSCH comprising DMRS type 2 on the DMRS ports corresponding to the entry, wherein the DMRS ports are at least one of (i) legacy ports or (ii) enhanced ports.

Other example embodiments are related to an apparatus having processing circuitry configured to generate, for transmission to a user equipment (UE), one or more messages comprising a plurality of tables, wherein each table comprises one or more entries related to a selection of demodulation reference signal (DMRS) ports for a Physical Uplink Shared Channel (PUSCH), generate, for transmission to the UE, a DMRS type 2 configuration for the PUSCH and process, based on signals received from the UE, the PUSCH comprising DMRS type 2 on the DMRS ports corresponding to the entry, wherein the DMRS ports are at least one of (i) legacy ports or (ii) enhanced ports.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a table corresponding to DMRS type 1.

FIG. 5 shows a table corresponding to DMRS type 2.

FIG. 6 shows a DMRS antenna port indication table, according to various example embodiments.

FIG. 7 shows an example table for DMRS type 2, with a maximum length of 1 symbol per DMRS location for rank 1 applied for DMRS antenna port indications according to various example embodiments.

FIG. 8 shows an example table for DMRS type 2, with a maximum length of 1 symbol per DMRS location for rank 2 applied for DMRS antenna port indications according to various example embodiments.

FIG. 9 shows an example table for DMRS type 2, with a maximum length of 1 symbol per DMRS location for rank 3 applied for DMRS antenna port indications according to various example embodiments.

FIG. 10 shows an example table for DMRS type 2, with a maximum length of 1 symbol per DMRS location for rank 4 applied for DMRS antenna port indications according to various example embodiments.

FIG. 11 shows an example table for DMRS type 2, with a maximum length of 1 symbol per DMRS location for rank 5 for DMRS antenna port indications according to various example embodiments.

FIG. 12 shows an example table for DMRS type 2, with a maximum length of 1 symbol per DMRS location for rank 6 for DMRS antenna port indications according to various example embodiments.

FIG. 13 shows an example table for DMRS type 2, with a maximum length of 1 symbol per DMRS location for rank 7 for DMRS antenna port indications according to various example embodiments.

FIG. 14 shows an example table for DMRS type 2, with a maximum length of 1 symbol per DMRS location for rank 8 for DMRS antenna port indications according to various example embodiments.

FIG. 15 shows an example table for DMRS type 2, with a maximum length of 2 symbols per DMRS location for rank 1 applied for DMRS antenna port indications according to various example embodiments.

FIG. 16 shows an example table for DMRS type 2, with a maximum length of 2 symbols per DMRS location for rank 2 applied for DMRS antenna port indications according to various example embodiments.

FIG. 17 shows an example table for DMRS type 2, with a maximum length of 2 symbols per DMRS location for rank 3 applied for DMRS antenna port indications according to various example embodiments.

FIG. 18 shows an example table for DMRS type 2, with a maximum length of 2 symbols per DMRS location for rank 4 applied for DMRS antenna port indications according to various example embodiments.

FIG. 19 shows an example table for DMRS type 2, with a maximum length of 2 symbols per DMRS location for rank 5 for DMRS antenna port indications according to various example embodiments.

FIG. 20 shows an example table for DMRS type 2, with a maximum length of 2 symbols per DMRS location for rank 6 according to various example embodiments.

FIG. 21 shows an example table for DMRS type 2, with a maximum length of 2 symbols per DMRS location for rank 7 for DMRS antenna port indications according to various example embodiments.

FIG. 22 shows an example table for DMRS type 2, with a maximum length of 2 symbols per DMRS location for rank 8 for DMRS antenna port indications according to various example embodiments.

FIG. 23 shows an example method where the network configures the UE with antenna port indication tables and the UE uses an appropriate entry to transmit the DMRS in the PUSCH according to various example embodiments.

### DETAILED DESCRIPTION

The example embodiments may be further understood with reference to the following description and the related appended drawings, wherein like elements are provided with the same reference numerals. The example embodiments are related to providing a user equipment (UE) with configuration tables for DMRS type 2 port selection for PUSCH.

The example embodiments are described with regard to a UE. However, reference to the term UE is merely provided for illustrative purposes. The example embodiments may be utilized with any electronic component that is configured with the hardware, software, and/or firmware to exchange information (e.g., control information) and/or data with the network. Therefore, the UE as described herein is used to represent any suitable electronic device that directly communicates with the network.

The example embodiments are also described with regard to a fifth generation (5G) New Radio (NR) network. However, reference to a 5G NR network is merely provided for illustrative purposes. The example embodiments may be utilized with any network that utilizes a cyclic prefix-orthogonal frequency division multiplexing (CP-OFDM) waveform in the uplink.

The example embodiments are described with regard to DMRS for a CP-OFDM waveform. As described above, DMRS is a reference signal that may be used for channel estimation. CP-OFDM may utilize DMRS to enable multiple layer transmissions where each layer corresponds to a different antenna port, e. g., DRMS port. The example embodiments described herein introduce techniques for increasing the number of supported DMRS ports for CP-OFDM in the UL, e.g., for the Physical Uplink Shared Channel (PUSCH). An increased number of DMRS ports may facilitate more efficient multi-user-multiple input multiple output (MU-MIMO) operations. However, the example embodiments are not limited to MU-MIMO operations.

There are two types of DMRS, Type 1 and Type 2. DMRS Type 1 uses 2 CDM group with each CDM group using every second resource element (RE) within the symbols allocated to DMRS. DMRS Type 2 uses 3 CDM groups with each CDM group using consecutive RE within the symbols allocated to DMRS. The example embodiments may be implemented with respect to DMRS Type 2. More specifically, the example embodiments are related to implementations of enhanced DMRS, e.g., DMRS type 2. As will be described in greater detail below, the enhanced DMRS may be transmitted using a larger number of orthogonal DMRS ports without increasing the DMRS overhead, e.g., by using a larger Frequency-Domain Orthogonal Cover Code (FD-OCC) to transmit the DMRS. The following will provide some examples of the characteristics of the enhanced DMRS, e.g., DMRS type 2.

As mentioned above, the example embodiments are described with regard to DMRS type 2. For both DMRS type 1 and DMRS type 2, multiple DMRS ports may be mapped to the same REs. For example, an orthogonal cover code (OCC) of length 4 may be used in the frequency domain to enable four DMRS ports to utilize the same RES (FD-OCC). When two symbol DMRS is utilized, the number of DMRS ports that may be mapped to the same REs may be further increased by using OCC of length 2 in the time domain (e.g., TD-OCC). Throughout this description, multiple DMRS ports that are configured to use the same REs but are separated in the code domain may be referred to as a “code division multiplex (CDM) group.” To differentiate between different CDM groups, the example embodiments may refer to CDM group 0, CDM group 1, CDM group 2, etc. Similarly, to differentiate between DMRS ports, the example embodiments may refer to port 0, port 1, port 2, port 3, port 4, etc. However, the manner in which CDM groups and DMRS ports are numbered throughout this description is merely provided for illustrative purposes and is not intended to limit the example embodiments in any way. Furthermore, DMRS type 1 may include two (2) CDM groups while DMRS type 2 may include three (3) CDM groups.

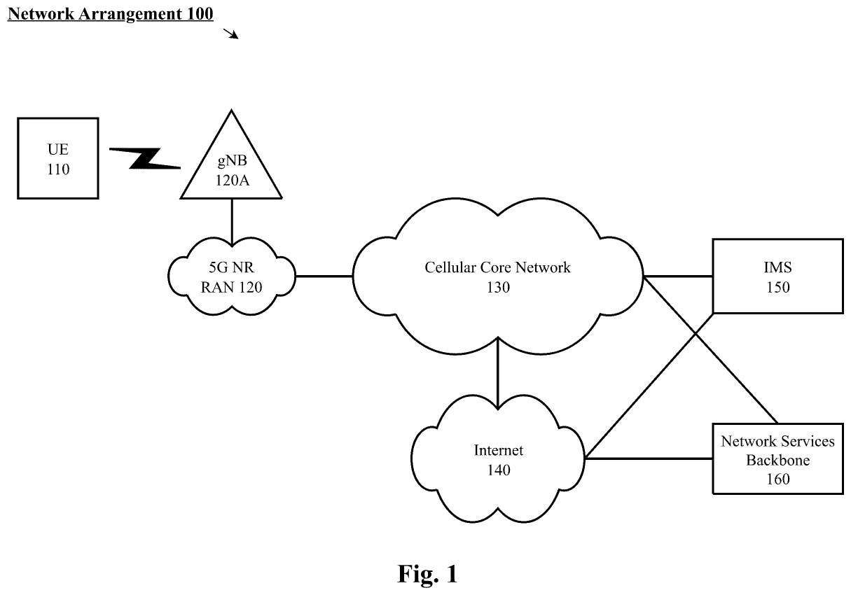

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., a 6G network, a 5G cloud RAN, a next generation RAN (NG-RAN), a long term evolution (LTE) RAN, a legacy cellular network, a WLAN, etc. ) and the UE 110 may also communicate with networks over a wired connection. With regard to the example embodiments, the UE 110 may establish a connection with the 5G NR RAN 120. Therefore, the UE 110 may have a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e. g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

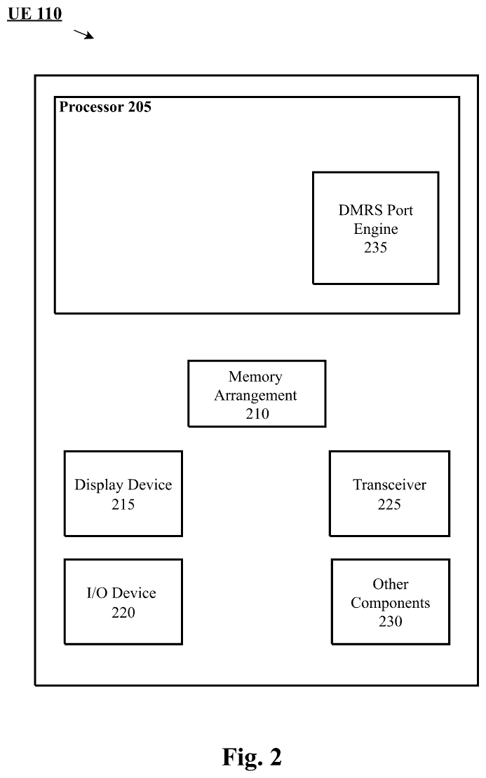

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a DMRS port engine 235. The DMRS port engine 235 may perform various operations such as, but not limited to, receiving tables related to DMRS port selections for PUSCH, selecting an entry comprising DMRS ports from the tables and transmitting the PUSCH comprising the DMRS using the selected DMRS ports. Each of these various operations will be described in greater detail below.

The above referenced DMRS port engine 235 being an application (e. g., a program) executed by the processor 205 is merely provided for illustrative purposes. The functionality associated with the DMRS port engine 235 may also be represented as a separate incorporated component of the UE 110 or may be a modular component coupled to the UE 110, e. g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120 and/or any other appropriate type of network. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

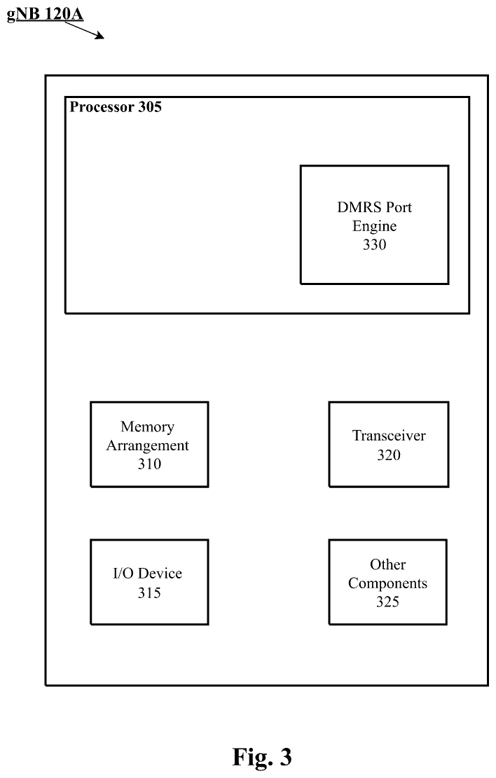

FIG. 3 shows an example base station 300 according to various example embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a DMRS port engine 330. The DMRS port engine 330 may perform various operations related to configuring the UE 110 with information to transmit PUSCH including DMRS. The operations may include but are not limited to, transmitting tables related to DMRS port selections for PUSCH, configuring a DMRS configuration for the UE and receiving the PUSCH comprising the DMRS using the selected DMRS ports. Each of these various operations will be described in greater detail below.

The above noted DMRS port engine 330 being an application (e.g., a program) executed by the processor 305 is only example. The functionality associated with the DMRS port engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e. g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

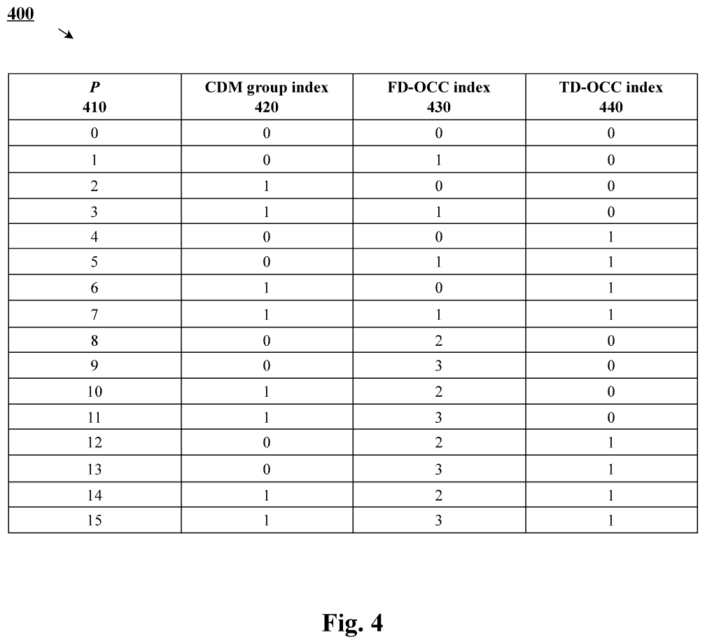

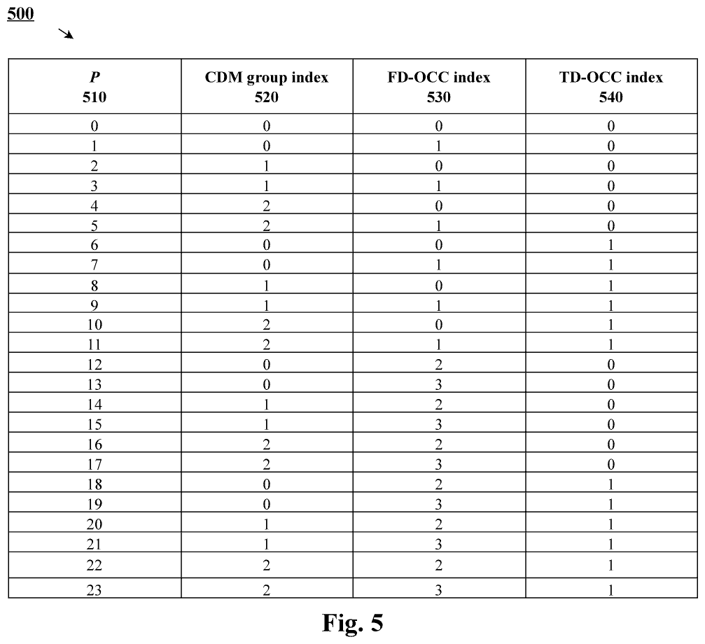

Prior to describing the example embodiments, the enhanced DMRS will be described in more detail with reference to FIGS. 4 and 5. FIG. 4 shows a table 400 corresponding to DMRS type 1. The table 400 includes four columns 410-440. The first column 410 shows the DMRS port index for DMRS type 1. As can be seen from the table 400, there are sixteen (indexed 0-15) possible DMRS ports for DMRS type 1. As described above, DMRS type 1 has two CDM groups. Thus, the column 420 of the table 400 shows the CDM group (0 or 1) to which each port index belongs, e. g., port index 0 belongs to CDM group 0, port index 1 belongs to CDM group 0, port index 2 belongs to CDM group 1, etc.).

As also described above, the DMRS type 1 may use a FD-OCC of length 4 in the frequency domain to enable four DMRS ports to utilize the same RE. Thus, the column 430 of the table 400 shows the FD-OCC index (0-3) to which each port index belongs, e.g., port index 0 belongs to FD-OCC index 0, port index 1 belongs to FD-OCC index 1, port index 8 belongs to FD-OCC index 2, port index 9 belongs to FD-OCC index 3, etc.).

As also described above, the DMRS type 1 may use a TD-OCC of length 2 (e.g., two symbols) in the time domain to further increase the number of DMRS ports to utilize the same RE. Thus, the column 440 of the table 400 shows the TD-OCC index (0-1) to which each port index belongs, e.g., port index 0 belongs to TD-OCC index 0, port index 4 belongs to TD-OCC index 1, etc.).

FIG. 5 shows a table 500 corresponding to DMRS type 2. The table 500 includes four columns 510-540 that correspond to the columns 410-440 described above with reference to table 400. The first column 510 shows the DMRS port index for DMRS type 2. As can be seen from the table 500, there are twenty-four (indexed 0-23) possible DMRS ports for DMRS type 2. As described above, DMRS type 2 has three CDM groups. Thus, the column 520 of the table 500 shows the CDM group (0-2) to which each port index belongs. The DMRS type 2 may also use a FD-OCC of length 4 in the frequency domain to enable four DMRS ports to utilize the same RE. Thus, the column 530 of the table 500 shows the FD-OCC index (0-3) to which each port index belongs. The DMRS type 2 may also use a TD-OCC of length 2 (e.g., two symbols) in the time domain. Thus, the column 540 of the table 500 shows the TD-OCC index (0-1) to which each port index belongs.

Thus, as can be seen from the tables 400 and 500, the DMRS type 1 may include 16 DMRS ports and the DMRS type 2 may include 24 DMRS ports. These tables 400 and 500 may be referred back to when describing the new antenna port tables of the example embodiments.

The following figures will provide various examples of the DMRS tables as described above. However, the tables and the various entries are only example and it is possible that a subset of entries for the tables may be used. Furthermore, the order of the entries in any of the tables may be different than what is illustrated in the figures.

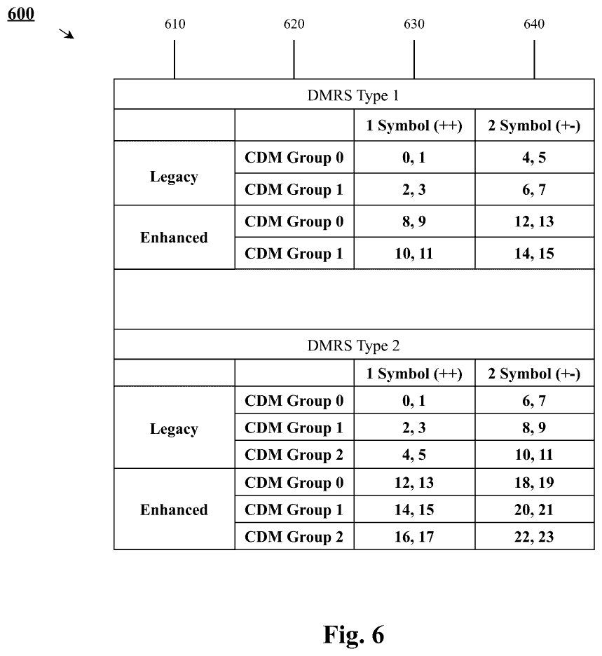

In a first aspect of the example embodiments, general principles will be described with respect to FIG. 6. FIG. 6 shows a DMRS antenna port indication table 600, according to various example embodiments. DMRS type 1 and DMRS type 2 are shown in the table 600. Column 610 indicates whether DMRS are part of an enhanced or legacy group of ports. For example, in DMRS type 1, CDM group 0 in 1 symbol legacy operations, the UE 110 would use DMRS ports 0 and 1 to transmit the DMRS type 1 on the PUSCH. In column 620, the CDM group is indicated. As discussed above, DMRS type 1 uses two groups (0-1), whereas DMRS type 2 uses three groups (0-2). Column 630 indicates ports to transmit the DMRS on the PUSCH for 1 symbol operation (e.g., max Length=1), and column 640 indicates ports to the DMRS on the PUSCH for 2 symbol operation (e. g., max Length=2).

In a first option of the first aspect, all the indicated antenna port(s) are legacy DMRS ports (e.g., the ports sharing a row with “legacy” in the table 600). In a second option, the indicated antenna port(s) are enhanced antenna ports (e.g., the legacy ports sharing a row with “enhanced” in the table 600). In a third option, the indicated antenna port(s) are a mixture of the legacy antenna ports and the enhanced antenna ports. The third option may be further narrowed, for example, all the indicated antenna ports may be in the same CDM group in some embodiments.

It should be noted that for enhanced DMRS Type 1 the legacy antenna ports are 0/1/2/3/4/5/6/7 and the enhanced antenna ports are port 8/9/10/11/12/13/14/15. For enhanced DMRS Type 2, the legacy antenna ports are ports 0/1/2/3/4/5/6/7/8/9/10/11 and the enhanced antenna ports are ports 12/13/14/15/16/17/18/19/20/21/22/23.

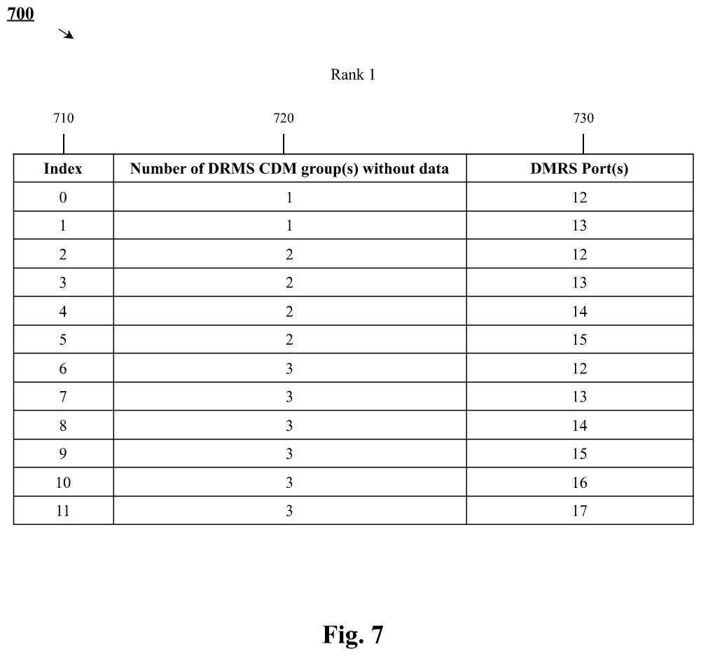

FIG. 7 shows an example table 700 for DMRS type 2, with a maximum length of 1 symbol per DMRS location for rank 1 applied for DMRS antenna port indications according to various example embodiments. The column 710 shows an index value for the entries of the table 700. The column 720 shows the number of DMRS CDM groups without data. As described above for DMRS type 2 there may be three CDM groups. However, there is no requirement that DMRS are transmitted for all of these CDM groups. When DMRS is transmitted on less than all of the three CDM groups, the resources for the other CDM group(s) may be used to transmit data in the PUSCH. The column 730 indicates the DMRS ports that the UE should use to transmit the DMRS type 2 on the PUSCH. Since this table 700 is for a rank 1 transmission there is one (1) DMRS port per entry. As will be described below, the example table 700 includes only enhanced DMRS type 2 ports for the scenario described (e.g., DMRS type 2, maximum length 1, rank 1).

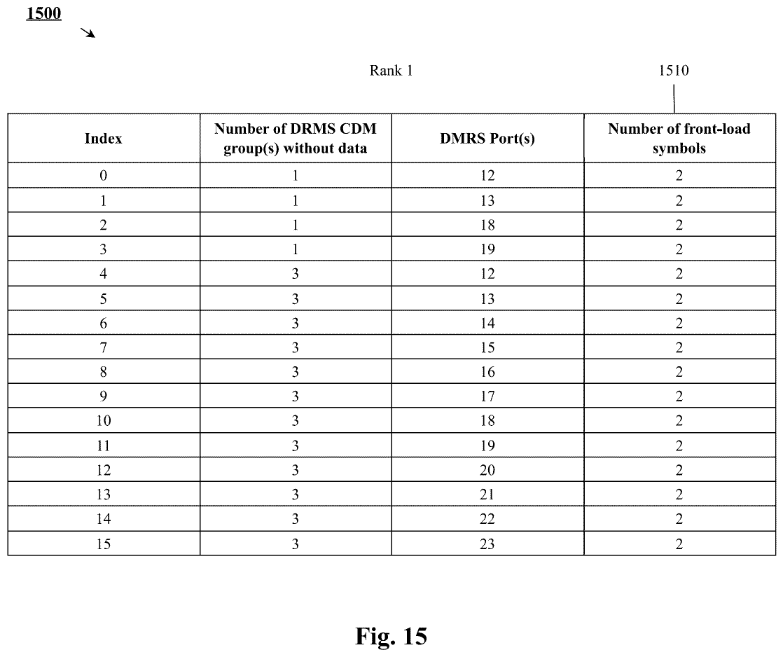

It should be noted that until FIG. 15 (which introduces two symbol tables), any reference to a “legacy” port refers to DMRS type 2, 1 symbol operation (e.g., ports 0-5). Similarly, any reference to an enhanced port until FIG. 15 should be understood to be a DMRS type 2, 1 symbol operation (e.g., ports 12-17). Appropriate indication will be provided in FIG. 15 and subsequent figures as to which ports the figure is referring.

Examples for the antenna port indications of the table 700 are illustrative. When the number of DMRS CDM groups without data (the column 720) is 1, there are two CDM groups with data (3 CDM groups-2 CDM groups with data=1 CDM group without data). Again, the enhanced 1 symbol DMRS type 2 begins at port 12 and ends at 17. In this case, DMRS port 12 (index 0) is used first (e. g., the first available port in CDM group 0 for enhanced 1 symbol DMRS type 2). The next port to be used (index 1) is DMRS port 13 corresponding to the next available port in CDM group 0.

When there are two CDM groups without data (shown by indices 2-5) the DMRS ports are used in a similar manner to the one CDM group without data scenario described above. The indices 2-5 show that the DMRS ports used in this scenario use DMRS port 12 (index 2, CDM group 0), port 13 (index 3, CDM group 0), port 14 (index 4, CDM group 1) and then port 15 (index 5, CDM group 0). Ports associated with CDM group 3 are not used in this example. However, this is only example as ports from CDM group 3 may be used.

If all three CDM groups are without data (indices 6-11), the logic of the previous examples is extrapolated. In this case, the three CDM groups may be filled sequentially. The ports 12 and 13 are used (indices 6 and 7, respectively, CDM group 0), then the ports 14 and 15 (indices 8 and 9, respectively, CDM group 1) and finally the ports 16 and 17 (indices 10 and 11, respectively, CDM group 3) are used.

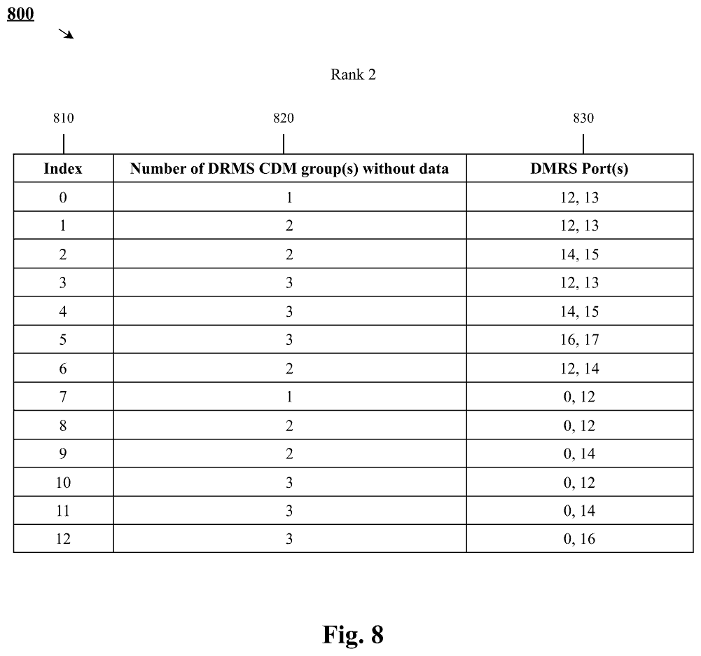

FIG. 8 shows an example table 800 for DMRS type 2, with a maximum length of 1 symbol per DMRS location for rank 2 applied for DMRS antenna port indications according to various example embodiments. It should be noted that indices 0-6 represent a first option, and indices 7-12 represent a second option. The columns 810-830 are similar to the columns 710-730 described above for the table 700, e.g., column 810 is an index value for the table entries, column 820 shows the number of DMRS CDM groups without data, and column 830 shows the DMRS ports that the UE should use to transmit the DMRS type 2 on the PUSCH when the entry is selected. Since this table 800 is for rank 2 transmissions, each entry of the table 800 comprises 2 DMRS ports.

In the first option, all enhanced DMRS type 2 ports are used. When the number of CDM groups without data is one (index 0) the DMRS ports used are 12 and 13 (CDM group 0).

When the number of CDM groups without data is two (indices 1 and 2), the DMRS ports used are 12 and 13 (CDM group 0) and then 14 and 15 (CDM group 1). In these examples, while there are 2 CDM groups without data available, the entries having the indices 1 and 2 still use 2 ports from the same CDM group. While the UE will use the ports from only one CDM group, this configuration may provide information to the UE. For example, this may indicate that another UE is using the other CDM group for DMRS transmission. The UE may use this information for such things as PUSCH rate matching, etc.

The index 6 entry shows an example of 2 CDM groups without data where ports from both CDM groups are used, e. g., port 12 from CDM group 0 and port 14 from CDM group 1.

When the number of CDM groups without data is three (indices 3-5), the logic continues where ports from a single CDM group are used, e.g., ports 12 and 13 from CDM group 0 (index 3), ports 14 and 15 from CDM group 1 (index 4) and ports 16 and 17 from CDM group 2 (index 5).

In the second option, a mixture of legacy ports and enhanced ports is used. Beginning with the index 7 with the number of CDM groups without data equal to 1, port 0 (the first port of the legacy 1 symbol ports) and port 12 (the first port of the enhanced 1 symbol ports) may be used.

In indices 8-9, with the number of CDM groups without data equal to 2, the index 8 entry is the same as the index 7 entry. The index 9 entry shows that it is possible to use a legacy port from CDM group 0 (port 0) along with an enhanced port from CDM group 1 (port 14).

In indices 10-12, with the number of CDM groups without data equal to 3, the index 10 entry is the same as the index 7 entry and the index 11 entry is the same as the index 9 entry. The index 12 entry shows that it is possible to use a legacy port from CDM group 0 (port 0) along with an enhanced port from CDM group 2 (port 16).

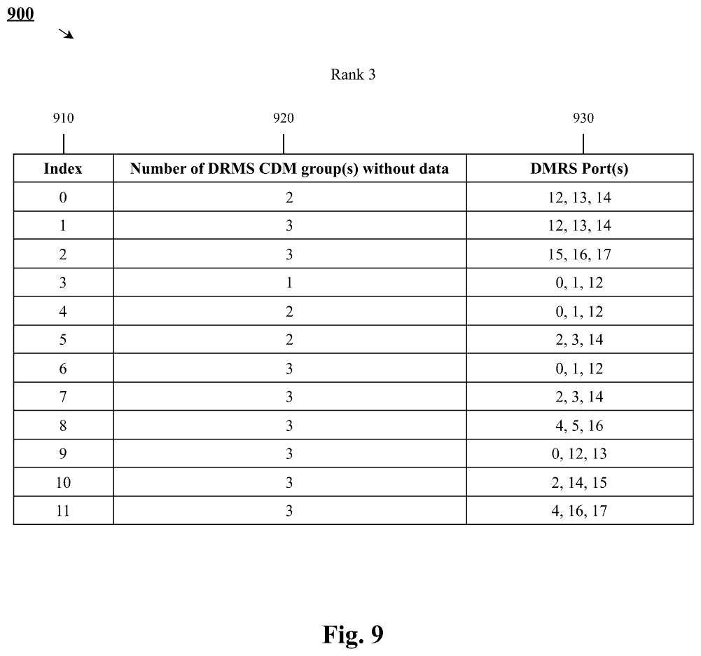

FIG. 9 shows an example table 900 for DMRS type 2, with a maximum length of 1 symbol per DMRS location for rank 3 applied for DMRS antenna port indications according to various example embodiments. It should be noted that indices 0-2 represent a first option, and indices 3-11 represent a second option. The columns 910-930 are similar to the columns 710-730 described above for the table 700, e.g., column 910 is an index value for the table entries, column 920 shows the number of DMRS CDM groups without data, and column 930 shows the DMRS ports that the UE should use to transmit the DMRS type 2 on the PUSCH when the entry is selected. Since this table 900 is for rank 3 transmissions, each entry of the table 900 comprises 3 DMRS ports.

In the first option only enhanced DMRS type 2 ports are used. When the number of DMRS CDM groups without data is 2, the DMRS ports used may be 12, 13, and 14 (the 2 enhanced ports from the 1 symbol CDM group 0 with the first available enhanced port of CDM group 1). This is shown as the entry with index 0.

When the number of DMRS CDM groups without data is 3, the index 1 entry is the same as the index 0 entry. The index 2 entry shows that it is also possible to use ports 15, 16, and 17 (second available enhanced port of 1 symbol CDM group 1 along with both enhanced ports from CDM group 2).

In the second option, a mixture of legacy and enhanced ports may be used. In the second option, when the number of DMRS CDM groups without data is 1 (e.g., all the DMRS ports need to be from the same CDM group), the DMRS ports used may be 0, 1, 12 (e.g., legacy ports from CDM group 0 along with the first available enhanced port of CDM group 0). This is shown in index 3.

When the number of DMRS CDM groups without data is 2, the index 4 entry is the same as the index 3 entry. The index 5 entry shows DMRS ports 2, 3, 14 (e. g., both legacy ports from CDM group 1 along with the first available enhanced port of CDM group 1).

When the number of DMRS CDM groups without data is 3, the entries with the indices 6-8 show examples of using both legacy ports from a 1 symbol CDM group along with one enhanced port of the same 1 symbol CDM group. The indices 9-11 show using one legacy port from a 1 symbol CDM group and two enhanced ports of the same 1 symbol CDM group. For example, index 10 uses legacy port 0 of CDM group 0 and uses enhanced ports 12 and 13 from CDM group 0. Similar logic is applied to indices 11 and 12, instead using CDM groups 1 and 2, respectively.

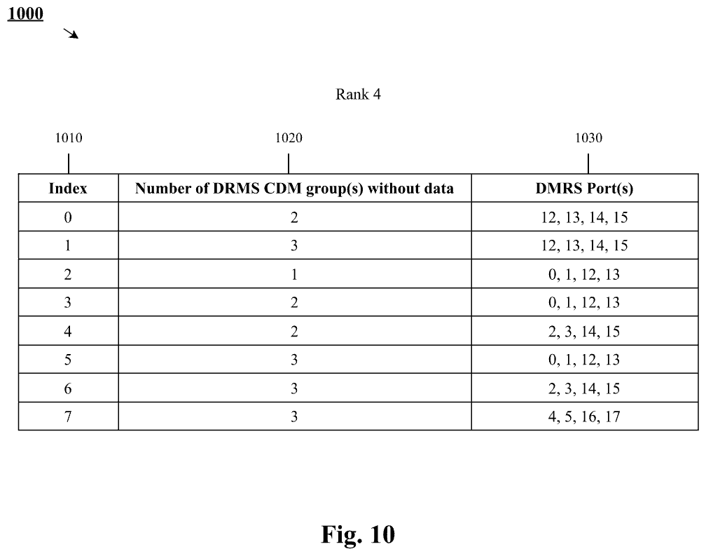

FIG. 10 shows an example table 1000 for DMRS type 2, with a maximum length of 1 symbol per DMRS location for rank 4 applied for DMRS antenna port indications according to various example embodiments. The indices 0-1 represent a first option, and the indices 2-7 represent a second option. The columns 1010-1030 are similar to the columns 710-730 described above for the table 700, e.g., column 1010 is an index value for the table entries, column 1020 shows the number of DMRS CDM groups without data, and column 1030 shows the DMRS ports that the UE should use to transmit the DMRS type 2 on the PUSCH when the entry is selected. Since this table 1000 is for rank 4 transmissions, each entry of the table 1000 comprises 4 DMRS ports.

In the first option only enhanced DMRS type 2 ports are used. When the number of DMRS CDM groups without data is 2 or 3 as shown for the indices 0 and 1, respectively, the DMRS ports used may be 12, 13, 14, and 15 (both enhanced ports from CDM group 0 and CDM group 1).

In the second option, a combination of legacy and enhanced DMRS type 2 ports may be used. This allows a combination of legacy and enhanced ports from a single CDM group to be used for DMRS transmissions as described in the various examples. When the number of DMRS CDM groups without data is 1 or 2 (indices 2 and 3), the DMRS ports used may be 0, 1, 12, and 13 (both legacy ports from CDM group 0 and both enhanced ports from CDM group 0). When the number of CDM groups without data is two, it is also possible to use ports 2, 3, 14, and 15 (both legacy ports from CDM group 1 and both enhanced ports from CDM group 1). This is shown in index 4. Similarly, when the number of DMRS CDM groups without data is 3, the DMRS ports used may be the legacy and enhanced ports from the same CDM group as shown in indices 5-7.

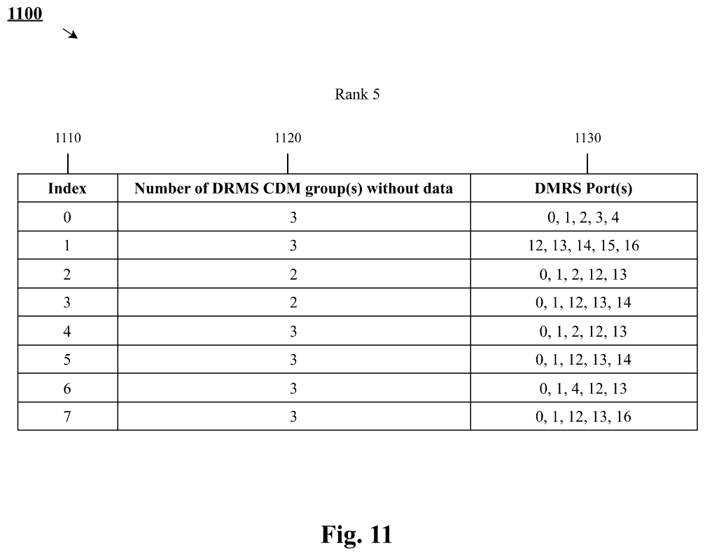

FIG. 11 shows an example table 1100 for DMRS type 2, with a maximum length of 1 symbol per DMRS location for rank 5 for DMRS antenna port indications according to various example embodiments. The index 0 represents a first option, index 1 represents a second option, and indices 2-7 represent a third option. The columns 1110-1130 are similar to the columns 710-730 described above for the table 700, e.g., column 1110 is an index value for the table entries, column 1120 shows the number of DMRS CDM groups without data, and column 1130 shows the DMRS ports that the UE should use to transmit the DMRS type 2 on the PUSCH when the entry is selected. Since this table 1100 is for rank 5 transmissions, each entry of the table 1100 comprises 5 DMRS ports.

In the first option, only legacy DMRS type 2 ports are used. The index 0 entry shows the legacy DMRS ports 0, 1, 2, 3, 4 (both legacy ports from CDM group 0 and group 1, and the first available legacy port of CDM group 2).

In the second option, only enhanced DMRS type 2 ports are used. The index 1 entry shows the enhanced DMRS ports 12, 13, 14, 15, 16 (both enhanced ports from CDM group 0 and group 1, and the first available enhanced port of CDM group 2).

In the third option a mixture of enhanced and legacy DMRS type 2 ports are used. For example, when the number of DMRS CDM groups without data is 2, the DMRS ports used may be 0, 1, 2, 12, 13, e.g., all enhanced and legacy ports from CDM group 0 and one legacy port from CDM group 1. This is shown in index 2. The index 3 shows the DMRS ports used may be 0, 1, 12, 13, 14, e.g., all enhanced and legacy ports from CDM group 0 and one enhanced port from CDM group 1. When the number of DMRS CDM groups without data is 3, the entries of indices 4-7 may be derived in a similar manner, e.g., all enhanced and legacy ports from a first CDM group 0 and one legacy port or one enhanced port from a second CDM group.

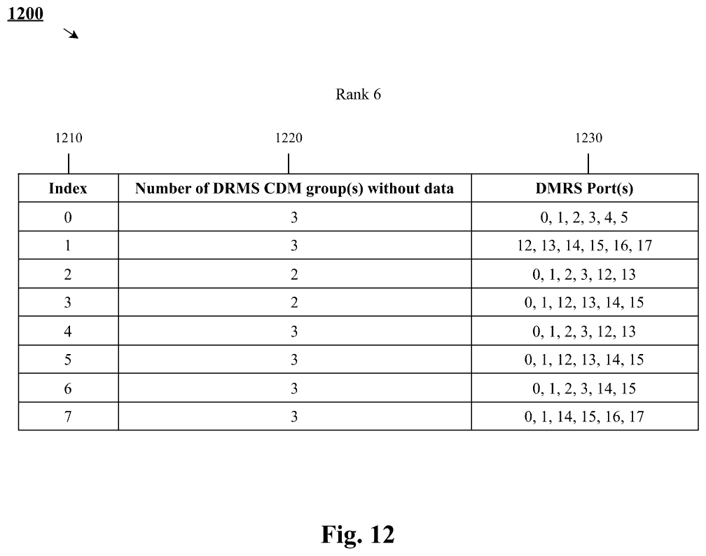

FIG. 12 shows an example table 1200 for DMRS type 2, with a maximum length of 1 symbol per DMRS location for rank 6 for DMRS antenna port indications according to various example embodiments. The index 0 represents a first option, index 1 represents a second option, and indices 2-7 represent a third option. The columns 1210-1230 are similar to the columns 710-730 described above for the table 700, e.g., column 1210 is an index value for the table entries, column 1220 shows the number of DMRS CDM groups without data, and column 1230 shows the DMRS ports that the UE should use to transmit the DMRS type 2 on the PUSCH when the entry is selected. Since this table 1200 is for rank 6 transmissions, each entry of the table 1200 comprises 6 DMRS ports.

In the first option only legacy DMRS type 2 ports are used. Since there are only six (6) legacy DMRS ports when the maximum length is 1, the number of DMRS CDM groups without data is 3, and the DMRS ports used may be 0, 1, 2, 3, 4, 5 (all legacy ports from all CDM groups). This is shown in index 0.

In the second option, only enhanced DMRS type 2 ports are used. Again, since there are only six (6) enhanced DMRS ports when the maximum length is 1, the number of DMRS CDM groups without data is 3, and the DMRS ports used may be 12, 13, 14, 15, 16, 17 (all enhanced ports from all. CDM groups). This is shown in index 1.

In the third option, a mixture of enhanced and legacy DMRS type 2 ports is used. For example, when there are two CDM groups without data, the index 2 shows an entry where all four legacy and enhanced ports from a first CDM group are used and both legacy ports from a second CDM group are used, e. g., DMRS ports 0, 1, 2, 3, 12, 13, (all legacy and enhanced ports from CDM group 0 and both legacy ports from CDM group 1). The index 3 shows an entry where all four legacy and enhanced ports from a first CDM group are used and both enhanced ports from a second CDM group are used, e.g., DMRS ports 0, 1, 12, 13, 14, 15 (all legacy and enhanced ports from CDM group 0 and both enhanced ports from CDM group 1).

When the number of DMRS CDM groups without data is 3, the entries with indices 4-6 may be derived in a similar manner as described above, e.g., all four legacy and enhanced ports from a first CDM group and either both enhanced ports or both legacy ports from a second CDM group. In another example, as shown by the index 7 entry, there may be 2 ports from a first CDM group, 2 ports from a second CDM group and 2 ports from a third CDM group. In the example of the index 7 entry, the DMRS ports are 0, 1, 14, 15, 16, 17, e.g., (both legacy ports from CDM group 0, both enhanced ports from CDM group 1, and both enhanced ports from CDM group 2).

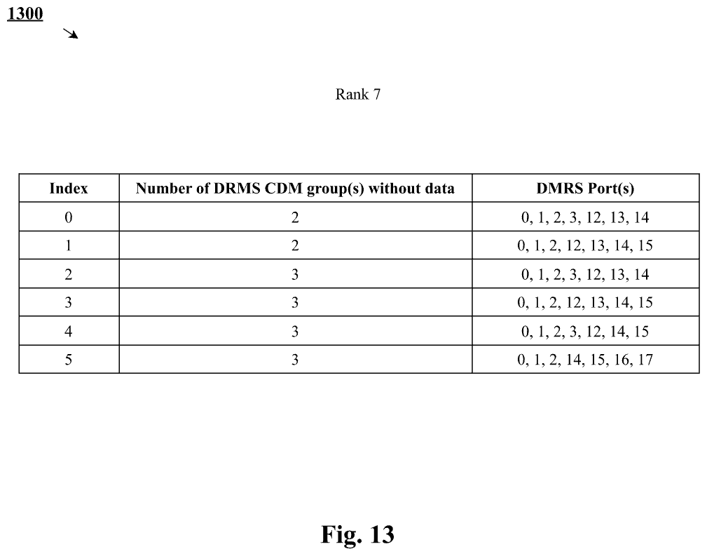

FIG. 13 shows an example table 1300 for DMRS type 2, with a maximum length 1 symbol per DMRS location for rank 7 for DMRS antenna port indications according to various example embodiments. Since this table 1300 is for rank 7 transmissions, each entry of the table 1300 comprises 7 DMRS ports. As described above, the legacy and enhanced 1 symbol DMRS type 2 each have only a total of six (6) DMRS ports. Thus, using only legacy or enhanced ports is not possible for rank 7 transmissions. Thus, the entries in the table 1300 include a mixture of legacy and enhanced ports. The entries in the table 1300 may be derived using the principles described above for the other example tables.

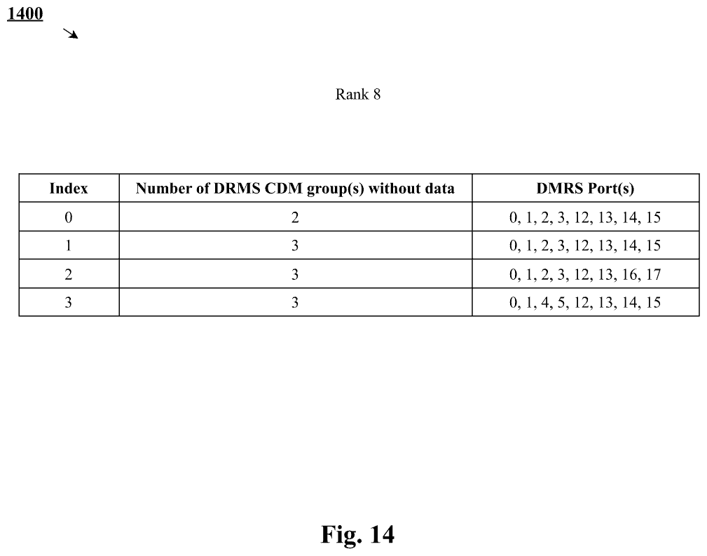

FIG. 14 shows an example table 1400 for DMRS type 2, with a maximum length of 1 symbol per DMRS location for rank 8 for DMRS antenna port indications according to various example embodiments. Since this table 1400 is for rank 8 transmissions, each entry of the table 1400 comprises 8 DMRS ports. Similar to the reasons described above for rank 7 transmissions, the entries in the table 1400 for rank 8 transmissions include a mixture of legacy and enhanced ports. The entries in the table 1400 may be derived using the principles described above for the other example tables.

DMRS type 2 may also use two symbols (e. g., maximum length of 2). FIG. 15 shows an example table 1500 for DMRS type 2, with a maximum length of 2 symbols per DMRS location for rank 1 applied for DMRS antenna port indications according to various example embodiments. It should be noted that for one symbol DRMS, the table 700 may be used instead of the table 1500 for rank 1.

In this example, the table 1500 includes an additional column 1510 that indicates a number of front loaded symbols. As described above, in this example, the maximum length is 2 meaning that 2 symbols may be used for the DMRS type 2 transmission. It is possible for the number of front loaded symbols may either be 1 or 2 (despite the example embodiments using 2 front loaded symbols). This value indicates how the DMRS ports should be allotted. This allotment will be described by way of example.

The entry of index 0 in the table 1500 has the number of front loaded symbols set to 2 in the column 1510. In this entry, the one (1) DMRS port indicated is DMRS port 12. The DMRS ports 12 belongs to CDM group 0. However, the DMRS port 12 of the CDM group 0 has a TD-OCC index of 0 (as shown in FIG. 5, index 12). Thus, because the number of front loaded symbols is 2 in this example, the selection of the DMRS port was based on the order the ports appear in the CDM group without regard to the TD-OCC index. In contrast, a number of front loaded symbols equal to 1 (one) would mean that the selection of the DMRS ports is weighted towards the first symbol.

The table 1500 is for a similar scenario as the table 700 except that this table 1500 is for two symbol rank 1 transmissions rather than one symbol rank 1 transmissions as in table 700. Each of the entries in the table 1500 use enhanced DMRS type 2 ports. Again, the entries in the table 1500 may be derived using the principles described above for the other example tables.

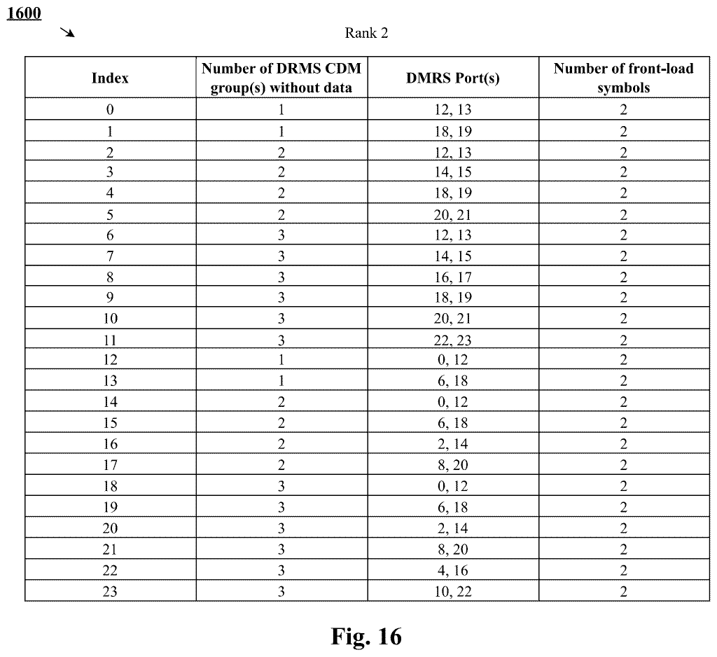

FIG. 16 shows an example table 1600 for DMRS type 2, with a maximum length of 2 symbols per DMRS location for rank 2 applied for DMRS antenna port indications according to various example embodiments. It should be noted that for one symbol DRMS, the table 800 may be used instead of the table 1600 for rank 2. The table 1600 is for a similar scenario as the table 800 except that this table 1600 is for two symbol rank 2 transmissions rather than one symbol rank 2 transmissions as in table 800.

The table 1600 shows two options. In a first option as shown for the entries of indices 0-11, only enhanced 2 symbol DMRS type 2 ports are used. In a second option as shown for the entries of indices 12-23, a combination of one (1) enhanced 2 symbol DMRS type 2 port and one (1) legacy 2 symbol DMRS type 2 port is used. The entries in the table 1600 may be derived using the principles described above for the other example tables.

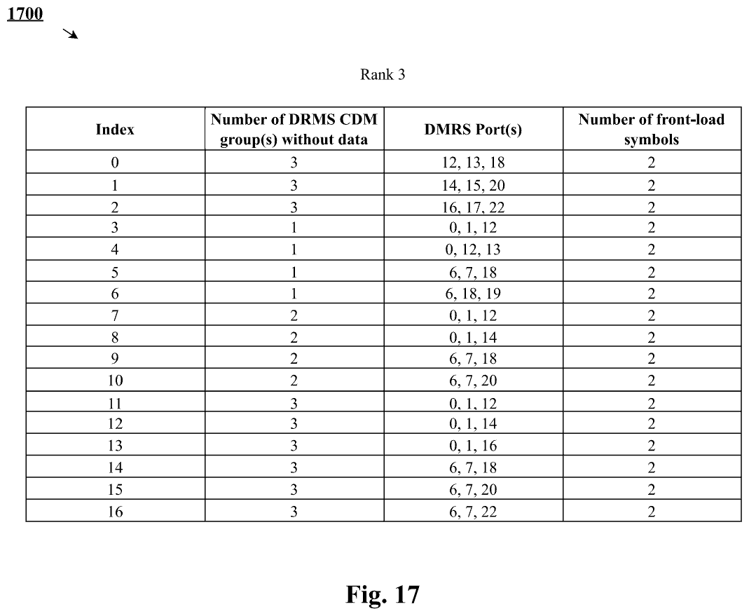

FIG. 17 shows an example table 1700 for DMRS type 2, with a maximum length of 2 symbols per DMRS location for rank 3 applied for DMRS antenna port indications according to various example embodiments. It should be noted that for one symbol DMRS, the table 900 may be used instead of the table 1700 for rank 3. The table 1700 is for a similar scenario as the table 900 except that this table 1700 is for two symbol rank 3 transmissions rather than one symbol rank 3 transmissions as in table 900.

The table 1700 shows two options. In a first option as shown for the entries of indices 0-2, only enhanced 2 symbol DMRS type 2 ports are used. In a second option as shown for the entries of indices 3-16, a combination of enhanced and legacy 2 symbol DMRS type 2 ports is used (e.g., 2 legacy ports and 1 enhanced port or 2 enhanced ports and 1 legacy port). The entries in the table 1700 may be derived using the principles described above for the other example tables.

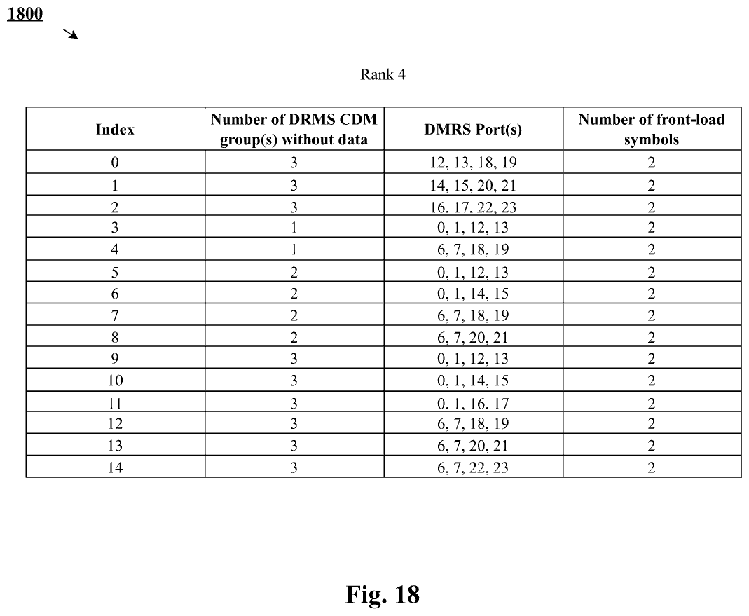

FIG. 18 shows an example table 1800 for DMRS type 2, with a maximum length of 2 symbols per DMRS location for rank 4 applied for DMRS antenna port indications according to various example embodiments. It should be noted that for one symbol DRMS, the table 1000 may be used instead of the table 1800 for rank 4. The table 1800 is for a similar scenario as the table 1000 except that this table 1800 is for two symbol rank 4 transmissions rather than one symbol rank 4 transmissions as in table 1000.

The table 1800 shows two options. In a first option as shown for the entries of indices 0-2, only enhanced 2 symbol DMRS type 2 ports are used. In a second option as shown for the entries of indices 3-14, a combination of two enhanced 2 symbol DMRS type 2 ports and two legacy 2 symbol DMRS type 2 ports is used. The entries in the table 1800 may be derived using the principles described above for the other example tables.

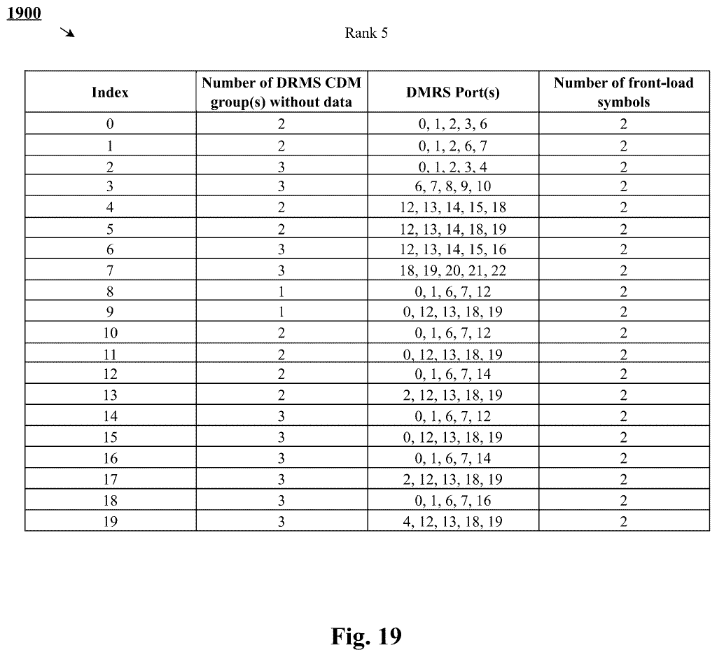

FIG. 19 shows an example table 1900 for DMRS type 2, with a maximum length of 2 symbols per DMRS location for rank 5 for DMRS antenna port indications according to various example embodiments. It should be noted that for one symbol DRMS, the table 1100 may be used instead of the table 1900 for rank 5. The table 1900 is for a similar scenario as the table 1100 except that this table 1900 is for two symbol rank 5 transmissions rather than one symbol rank 5 transmissions as in table 1100.

The table 1900 shows three options. In a first option as shown for the entries of indices 0-3, only legacy 2 symbol DMRS type 2 ports are used. In a second option as shown for the entries of indices 4-7, only enhanced 2 symbol DMRS type 2 ports are used. In a third option as shown for the entries of indices 8-19, a combination of either four enhanced 2 symbol DMRS type 2 ports and one legacy 2 symbol DMRS type 2 port or four legacy 2 symbol DMRS type 2 ports and one enhanced 2 symbol DMRS type 2 port is used. The entries in the table 1900 may be derived using the principles described above for the other example tables.

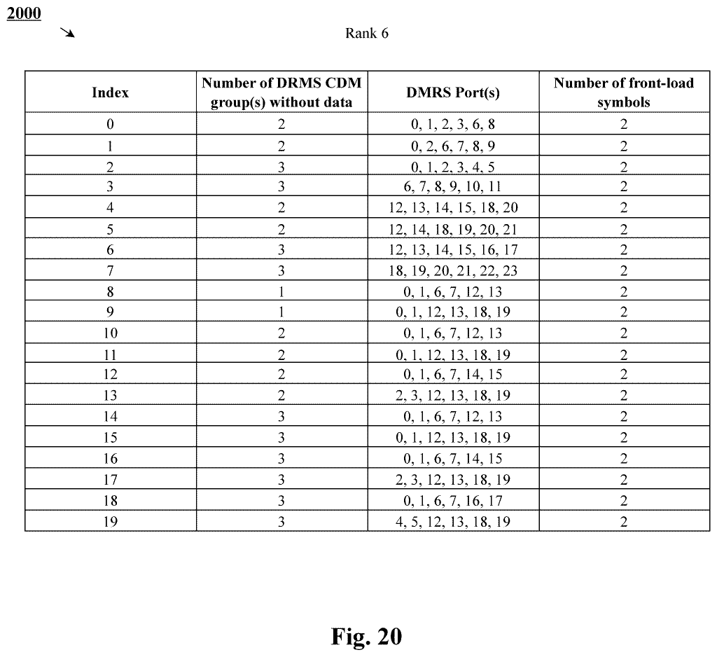

FIG. 20 shows an example table 2000 for DMRS type 2, with a maximum length of 2 symbols per DMRS location for rank 6 according to various example embodiments. It should be noted that for one symbol DRMS, the table 1200 may be used instead of the table 2000 for rank 6. The table 2000 is for a similar scenario as the table 1200 except that this table 2000 is for two symbol rank 6 transmissions rather than one symbol rank 6 transmissions as in table 1200.

The table 2000 shows three options. In a first option as shown for the entries of indices 0-3, only legacy 2 symbol DMRS type 2 ports are used. In a second option as shown for the entries of indices 4-7, only enhanced 2 symbol DMRS type 2 ports are used. In a third option as shown for the entries of indices 8-19, a combination of either four enhanced 2 symbol DMRS type 2 ports and two legacy 2 symbol DMRS type 2 ports or four legacy 2 symbol DMRS type 2 ports and two enhanced 2 symbol DMRS type 2 ports is used. The entries in the table 2000 may be derived using the principles described above for the other example tables.

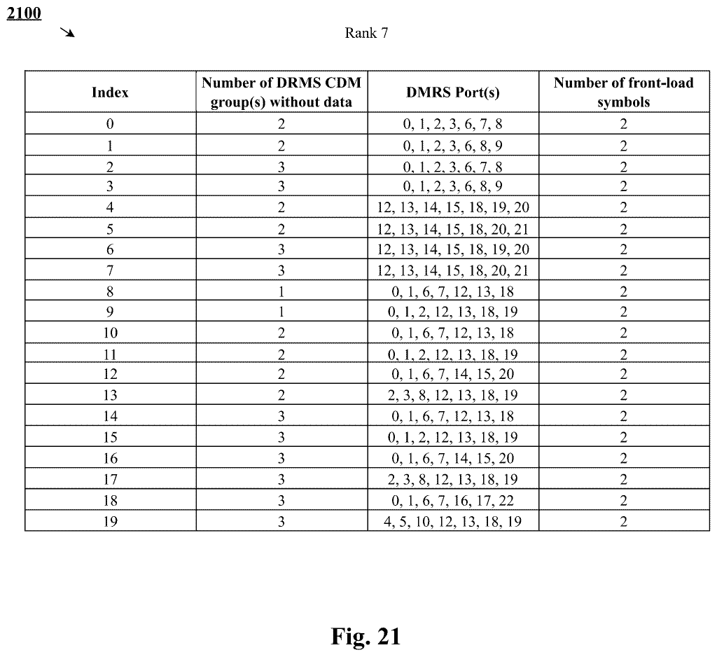

FIG. 21 shows an example table 2100 for DMRS type 2, with a maximum length of 2 symbols per DMRS location for rank 7 for DMRS antenna port indications according to various example embodiments. It should be noted that for one symbol DRMS, the table 1300 may be used instead of the table 2100 for rank 7. The table 2100 is for a similar scenario as the table 1300 except that this table 2100 is for two symbol rank 7 transmissions rather than one symbol rank 7 transmissions as in table 1300.

The table 2100 shows three options. In a first option as shown for the entries of indices 0-3, only legacy 2 symbol DMRS type 2 ports are used. In a second option as shown for the entries of indices 4-7, only enhanced 2 symbol DMRS type 2 ports are used. In a third option as shown for the entries of indices 8-19, a combination of either four enhanced 2 symbol DMRS type 2 ports and three legacy 2 symbol DMRS type 2 ports or four legacy 2 symbol DMRS type 2 ports and three enhanced 2 symbol DMRS type 2 ports is used. The entries in the table 2100 may be derived using the principles described above for the other example tables.

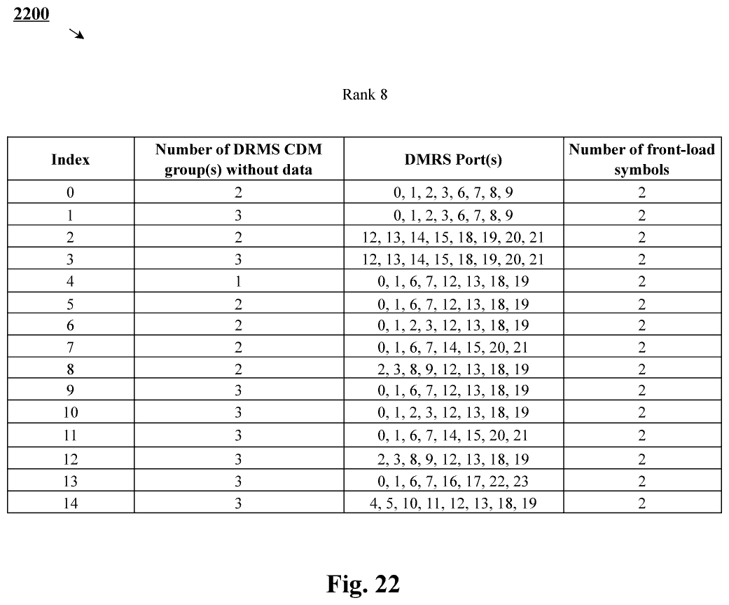

FIG. 22 shows an example table 2200 for DMRS type 2, with a maximum length of 2 symbols per DMRS location for rank 8 for DMRS antenna port indications according to various example embodiments. It should be noted that for one symbol DRMS, the table 1400 may be used instead of the table 2200 for rank 8. The table 2200 is for a similar scenario as the table 1400 except that this table 2200 is for two symbol rank 8 transmissions rather than one symbol rank 8 transmissions as in table 1400.

The table 2200 shows three options. In a first option as shown for the entries of indices 0-1, only legacy 2 symbol DMRS type 2 ports are used. In a second option as shown for the entries of indices 2-3, only enhanced 2 symbol DMRS type 2 ports are used. In a third option as shown for the entries of indices 3-14, a combination of four enhanced 2 symbol DMRS type 2 ports and four legacy 2 symbol DMRS type 2 ports is used. The entries in the table 2200 may be derived using the principles described above for the other example tables.

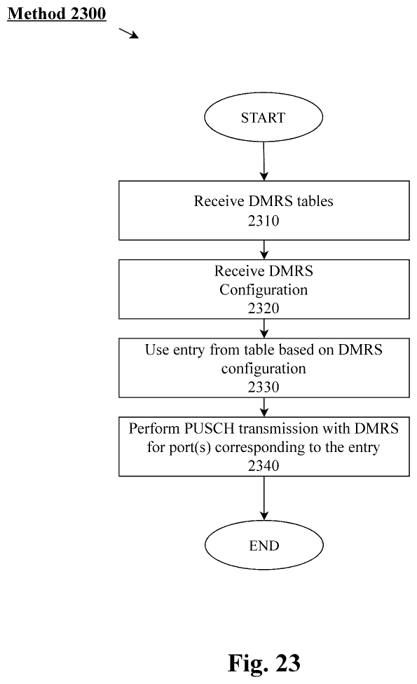

FIG. 23 shows an example method 2300 where the network configures the UE 110 with antenna port indication tables and the UE 110 uses an appropriate entry to transmit the DMRS in the PUSCH according to various example embodiments.

In 2310, the UE 110 receives from the network one or more indication tables for each scenario, e. g., the tables 700-2200 described above.

In 2320, the UE 110 receives a DMRS configuration for PUSCH from the network.

In 2330, the UE 110 determines the DMRS ports for the PUSCH transmission based on a configured entry from the table appropriate for the given situation (e.g., length, rank).

In 2340, the UE 110 will transmit the PUSCH including the selected DMRS ports based on the table.

### EXAMPLES

In first example, a method comprising receiving, from a network, a plurality of tables, wherein each table comprises one or more entries related to a selection of demodulation reference signal (DMRS) ports for a Physical Uplink Shared Channel (PUSCH), receiving, from the network, a DMRS type 2 configuration for the PUSCH, selecting an entry from one of the plurality of tables based on the DMRS configuration and transmitting the PUSCH comprising DMRS type 2 on the DMRS ports corresponding to the entry, wherein the DMRS ports are at least one of (i) legacy ports or (ii) enhanced ports.

In a second example, the method of the first example, wherein the entry comprises all legacy ports.

In a third example, the method of the first example, wherein the entry comprises all enhanced ports.

In a fourth example, the method of the first example, wherein the entry comprises a combination of enhanced ports and legacy ports.

In a fifth example, the method of the first example, wherein each of the plurality of tables corresponds to a scenario based on (i) a maximum length of symbols used to transmit the DMRS and (ii) a rank of the PUSCH.

In a sixth example, the method of the fifth example, wherein a code division multiplex (CDM) group supports multiplexing four DMRS Type 2 per symbol, and wherein DMRS Type 2 supports three CDM groups per symbol.

In a seventh example, the method of the sixth example, wherein a first table corresponds to a maximum length of 1 symbol and a rank of 1, wherein the entry comprises one enhanced DMRS port from one of the three CDM groups.

In an eighth example, the method of the sixth example, wherein a second table corresponds to a maximum length of 1 symbol and a rank of 2, wherein the entry comprises two DMRS ports.

In a ninth example, the method of the eighth example, wherein the second table comprises (i) a first entry having a selection of two enhanced DMRS ports from a same CDM group, (ii) a second entry having a selection of one enhanced DMRS port from a first CDM group and one enhanced DMRS port from a second CDM group, (iii) a third entry having a selection of one legacy DMRS port and one enhanced DMRS port from a same CDM group, and (iv) a fourth entry having a selection one legacy DMRS port from the first CDM group and one enhanced DMRS port from the second CDM group.

In a tenth example, the method of the sixth example, wherein a third table corresponds to a maximum length of 1 symbol and a rank of 3, wherein the entry comprises three DMRS ports.

In an eleventh example, the method of the tenth example, wherein the third table comprises (i) a first entry having a selection of two enhanced DMRS ports from a first CDM group and one enhanced DMRS port from a second CDM group, (ii) a second entry having a selection of two legacy DMRS ports and one enhanced DMRS port from a same CDM group, and (iii) a third entry having a selection of one legacy DMRS port and two enhanced DMRS ports from a same CDM group.

In a twelfth example, the method of the sixth example, wherein a fourth table corresponds to a maximum length of 1 symbol and a rank of 4, wherein the entry comprises four DMRS ports.

In a thirteenth example, the method of the twelfth example, wherein the fourth table comprises (i) a first entry having a selection of two enhanced DMRS ports from a first CDM group and two enhanced DMRS ports from a second CDM group, and (ii) a second entry having a selection of two legacy DMRS ports and two enhanced DMRS ports from a same CDM group.

In a fourteenth example, the method of the sixth example, wherein a fifth table corresponds to a maximum length of 1 symbol and a rank of 5, wherein the entry comprises five DMRS ports.

In a fifteenth example, the method of the fourteenth example, wherein the fifth table comprises (i) a first entry having a selection of two enhanced DMRS ports from a first CDM group, two enhanced DMRS ports from a second CDM group and one enhanced DMRS port from a third CDM group, (ii) a second entry having a selection of two legacy DMRS ports from a first CDM group, two legacy DMRS ports from a second CDM group and one legacy DMRS port from a third CDM group, (iii) a third entry having a selection of two legacy DMRS ports from a first CDM group, two enhanced DMRS ports from the first CDM group and one legacy DMRS port from a second CDM group, and (iv) a fourth entry having a selection of two legacy DMRS ports from a first CDM group and two enhanced DMRS ports from the first CDM group and one enhanced DMRS port from a second CDM group.

In a sixteenth example, the method of the sixth example, wherein a sixth table corresponds to a maximum length of 1 symbol and a rank of 6, wherein the entry comprises six DMRS ports.

In a seventeenth example, the method of the sixteenth example, wherein the sixth table comprises (i) a first entry having a selection of six legacy DMRS ports from the three CDM groups, (ii) a second entry having a selection of six enhanced DMRS ports from the three CDM groups, (iii) a third entry having a selection of two legacy DMRS ports from a first CDM group and two legacy DMRS ports from a second CDM group and two enhanced DMRS ports from the first CDM group, (iv) a fourth entry having a selection of two legacy DMRS ports from a first CDM group, two enhanced DMRS ports from the first CDM group and two enhanced DMRS ports from a second same CDM group, and (v) a fifth entry having a selection of two legacy DMRS ports from a first CDM group, two enhanced DMRS ports from a second CDM group and two enhanced DMRS ports from a third CDM group.

In an eighteenth example, the method of the sixth example, wherein a seventh table corresponds to a maximum length of 1 symbol and a rank of 7, wherein the entry comprises seven DMRS ports.

In a nineteenth example, the method of the eighteenth example, wherein the seventh table comprises (i) a first entry having a selection of two legacy DMRS ports from a first CDM group, two legacy DMRS ports from a second CDM group, two enhanced DMRS ports from the first CDM group and one enhanced DMRS port from the second CDM group, (ii) a second entry having a selection of two legacy DMRS ports from a first CDM group, one legacy DMRS port from a second CDM group, two enhanced DMRS ports from the first CDM group and two enhanced DMRS ports from the second CDM group, and (iii) a third entry having a selection of two legacy DMRS ports from a first CDM group, two legacy DMRS ports from a second CDM group, one enhanced DMRS port from the first CDM group and two enhanced DMRS ports from the second CDM group.

In a twentieth example, the method of the sixth example, wherein an eighth table corresponds to a maximum length of 1 symbol and a rank of 8, wherein the entry comprises eight DMRS ports.

In a twenty first example, the method of the twentieth example, wherein the eighth table comprises a first entry having a selection of two legacy DMRS ports from a first CDM group, two legacy DMRS ports from a second CDM group, two enhanced DMRS ports from the first CDM group and two enhanced DMRS ports from the second CDM group.

In a twenty second example, the method of the sixth example, wherein a ninth table corresponds to a maximum length of 2 symbols and a rank of 1, wherein the entry comprises one enhanced DMRS port from one of the three CDM groups.

In a twenty third example, the method of the sixth example, wherein a tenth table corresponds to a maximum length of 2 symbols and a rank of 2, wherein the entry comprises two DMRS ports.

In a twenty fourth example, the method of the twenty third example, wherein the tenth table comprises (i) a first entry having a selection of two enhanced DMRS ports from a same CDM group, and (ii) a second entry having a selection of one legacy DMRS port and one enhanced DMRS port from a same CDM group.

In a twenty fifth example, the method of the sixth example, wherein an eleventh table corresponds to a maximum length of 2 symbols and a rank of 3, wherein the entry comprises three DMRS ports.

In a twenty sixth example, the method of the twenty fifth example, wherein the eleventh table comprises (i) a first entry having a selection of three enhanced DMRS ports from a same CDM group, (ii) a second entry having a selection of two legacy DMRS ports and one enhanced DMRS port from a same CDM group, (iii) a third entry having a selection of one legacy DMRS port and two enhanced DMRS ports from a same CDM group, and (iv) a fourth entry having a selection of two legacy DMRS ports from a first CDM group and one enhanced DMRS port from a second CDM group.

In a twenty seventh example, the method of the sixth example, wherein a twelfth table corresponds to a maximum length of 2 symbols and a rank of 4, wherein the entry comprises four DMRS ports.

In a twenty eighth example, the method of the twenty seventh example, wherein the twelfth table comprises (i) a first entry having a selection of four enhanced DMRS ports from a same CDM group, (ii) a second entry having a selection of two legacy DMRS ports and two enhanced DMRS port from a same CDM group, iii) a third entry having a selection of two legacy DMRS ports from a first CDM group and two enhanced DMRS port from a second CDM group.

In a twenty ninth example, the method of the sixth example, wherein a thirteenth table corresponds to a maximum length of 2 symbols and a rank of 5, wherein the entry comprises five DMRS ports.

In a thirtieth example, the method of the twenty ninth example, wherein the thirteenth table comprises (i) a first entry having a selection of three legacy DMRS ports from a first CDM group and two legacy DMRS ports from a second CDM group, (ii) a second entry having a selection of four legacy DMRS ports from a first CDM group and one legacy DMRS port from a second CDM group, (iii) a third entry having a selection of two legacy DMRS ports from a first CDM group, two legacy DMRS ports from a second CDM group and one legacy DMRS port from a third CDM group, (iv) a fourth entry having a selection of three enhanced DMRS ports from a first CDM group and two enhanced DMRS ports from a second CDM group, v) a fifth entry having a selection of four enhanced DMRS ports from a first CDM group and one enhanced DMRS port from a second CDM group, vi) a sixth entry having a selection of four legacy DMRS ports and one enhanced DMRS port from a same CDM group, vii) a seventh entry having a selection of four enhanced DMRS ports and one legacy DMRS port from a same CDM group, viii) an eighth entry having a selection of four enhanced DMRS ports from a first CDM group and one legacy DMRS port from a second CDM group, and ix) a ninth entry having a selection of four legacy DMRS ports from a first CDM group and one enhanced DMRS port from a second CDM group.

In a thirty first example, the method of the sixth example, wherein a fourteenth table corresponds to a maximum length of 2 symbols and a rank of 6, wherein the entry comprises six DMRS ports.

In a thirty second example, the method of the thirty first example, wherein the fourteenth table comprises (i) a first entry having a selection of three legacy DMRS ports from a first CDM group and three legacy DMRS ports from a second CDM group, (ii) a second entry having a selection of two legacy DMRS ports from a first CDM group, two legacy DMRS ports from a second CDM group, and two legacy DMRS ports from a third CDM group (iii) a third entry having a selection of three enhanced DMRS ports from a first CDM group and three enhanced DMRS ports from a second CDM group, (iv) a fourth entry having a selection of two enhanced DMRS ports from a first CDM group, two enhanced DMRS ports from a second CDM group, and two enhanced DMRS ports from a third CDM group, (v) a fifth entry having a selection of four legacy DMRS ports and two enhanced DMRS ports from a same CDM group, (vi) a sixth entry having a selection of two legacy DMRS ports and four enhanced DMRS ports from a same CDM group, (vii) a seventh entry having a selection of four legacy DMRS ports from a first CDM group and two enhanced DMRS ports from a second CDM group, and (vii) a seventh entry having a selection of two legacy DMRS ports from a first CDM group and four enhanced DMRS ports from a second CDM group.

In a thirty third example, the method of the sixth example, wherein a fifteenth table corresponds to a maximum length of 2 symbols and a rank of 7, wherein the entry comprises seven DMRS ports.

In a thirty fourth example, the method of the thirty third example, wherein the fifteenth table comprises (i) a first entry having a selection of four legacy DMRS ports from a first CDM group and three legacy DMRS ports from a second CDM group, (ii) a second entry having a selection of four enhanced DMRS ports from a first CDM group and three enhanced DMRS ports from a second CDM group, (iii) a third entry having a selection of four legacy DMRS ports and three enhanced DMRS ports from a same CDM group, (iv) a fourth entry having a selection of three legacy DMRS ports and four enhanced DMRS ports from a same CDM group, (v) a fifth entry having a selection of four legacy DMRS ports from a first CDM group and three enhanced DMRS ports from a second CDM group, and (vi) a sixth entry having a selection of three legacy DMRS ports from a first CDM group and four enhanced DMRS ports from a second CDM group.

In a thirty fifth example, the method of the sixth example, wherein a sixteenth table corresponds to a maximum length of 2 symbols and a rank of 8, wherein the entry comprises eight DMRS ports.

In a thirty sixth example, the method of the thirty fifth example, wherein the sixteenth table comprises (i) a first entry having a selection of four legacy DMRS ports from a first CDM group and four legacy DMRS ports from a second CDM group, (ii) a second entry having a selection of four enhanced DMRS ports from a first CDM group and four enhanced DMRS ports from a second CDM group, (iii) a third entry having a selection of four legacy DMRS ports and four enhanced DMRS ports from a same CDM group, and (iv) a fourth entry having a selection of two legacy DMRS ports from a first CDM group, two legacy DMRS ports from a second CDM group and four enhanced DMRS ports from the first CDM group, and (v) a fifth entry having a selection of four legacy DMRS ports from a first CDM group and four enhanced DMRS ports from a second CDM group.

In a thirty seventh example, a processor configured to perform any of the first through thirty sixth examples.

In a thirty eighth example, a user equipment (UE) comprising a transceiver configured to communicate with a network and a processor communicatively coupled to the transceiver and configured to perform any of the first through thirty sixth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signals received from a network, a plurality of tables, wherein each table comprises one or more entries related to a selection of demodulation reference signal (DMRS) ports for a Physical Uplink Shared Channel (PUSCH) ;
process, based on signals received from the network, a DMRS type 2 configuration for the PUSCH;
select an entry from one of the plurality of tables based on the DMRS configuration; and
generate, for transmission, the PUSCH comprising DMRS type 2 on the DMRS ports corresponding to the entry, wherein the DMRS ports are at least one of (i) legacy ports or (ii) enhanced ports.

2. The apparatus of claim 1, wherein the entry comprises all legacy ports, all enhanced ports or a combination of enhanced ports and legacy ports.

3. The apparatus of claim 1, wherein each of the plurality of tables corresponds to a scenario based on (i) a maximum length of symbols used to transmit the DMRS and (ii) a rank of the PUSCH, and wherein a code division multiplex (CDM) group supports multiplexing four DMRS Type 2 per symbol, and wherein DMRS Type 2 supports three CDM groups per symbol.

4. The apparatus of claim 3, wherein a first table corresponds to a maximum length of 1 symbol and a rank of 1, wherein the entry comprises one enhanced DMRS port from one of the three CDM groups.

5. The apparatus of claim 3, wherein a second table corresponds to a maximum length of 1 symbol and a rank of 2, wherein the entry comprises two DMRS ports, wherein the second table comprises (i) a first entry having a selection of two enhanced DMRS ports from a same CDM group, and (ii) a second entry having a selection of one enhanced DMRS port from a first CDM group and one enhanced DMRS port from a second CDM group.

6. The apparatus of claim 3, wherein a third table corresponds to a maximum length of 1 symbol and a rank of 3, wherein the entry comprises three DMRS ports, wherein the third table comprises (i) a first entry having a selection of two enhanced DMRS ports from a first CDM group and one enhanced DMRS port from a second CDM group, (ii) a second entry having a selection of two legacy DMRS ports and one enhanced DMRS port from a same CDM group, and (iii) a third entry having a selection of one legacy DMRS port and two enhanced DMRS ports from a same CDM group.

7. The apparatus of claim 3, wherein a fourth table corresponds to a maximum length of 1 symbol and a rank of 4, wherein the entry comprises four DMRS ports, wherein the fourth table comprises (i) a first entry having a selection of two enhanced DMRS ports from a first CDM group and two enhanced DMRS ports from a second CDM group, and (ii) a second entry having a selection of two legacy DMRS ports and two enhanced DMRS ports from a same CDM group.

8. The apparatus of claim 3, wherein a fifth table corresponds to a maximum length of 1 symbol and a rank of 5, wherein the entry comprises five DMRS ports, wherein the fifth table comprises an entry having a selection of two legacy DMRS ports from a first CDM group, two legacy DMRS ports from a second CDM group and one legacy DMRS port from a third CDM group.

9. The apparatus of claim 3, wherein a sixth table corresponds to a maximum length of 1 symbol and a rank of 6, wherein the entry comprises six DMRS ports, wherein the entry comprises a selection of six legacy DMRS ports from the three CDM groups.

10. The apparatus of claim 3, wherein a seventh table corresponds to a maximum length of 1 symbol and a rank of 7, wherein the entry comprises seven DMRS ports, wherein the seventh table comprises (i) a first entry having a selection of two legacy DMRS ports from a first CDM group, two legacy DMRS ports from a second CDM group, two enhanced DMRS ports from the first CDM group and one enhanced DMRS port from the second CDM group, (ii) a second entry having a selection of two legacy DMRS ports from a first CDM group, one legacy DMRS port from a second CDM group, two enhanced DMRS ports from the first CDM group and two enhanced DMRS ports from the second CDM group, and (iii) a third entry having a selection of two legacy DMRS ports from a first CDM group, two legacy DMRS ports from a second CDM group, one enhanced DMRS port from the first CDM group and two enhanced DMRS ports from the second CDM group.

11. The apparatus of claim 3, wherein an eighth table corresponds to a maximum length of 1 symbol and a rank of 8, wherein the entry comprises eight DMRS ports, wherein the eighth table comprises a first entry having a selection of two legacy DMRS ports from a first CDM group, two legacy DMRS ports from a second CDM group, two enhanced DMRS ports from the first CDM group and two enhanced DMRS ports from the second CDM group.

12. The apparatus of claim 3, wherein a ninth table corresponds to a maximum length of 2 symbols and a rank of 1, wherein the entry comprises one enhanced DMRS port from one of the three CDM groups.

13. The apparatus of claim 3, wherein a tenth table corresponds to a maximum length of 2 symbols and a rank of 2, wherein the entry comprises two DMRS ports, wherein the tenth table comprises (i) a first entry having a selection of two enhanced DMRS ports from a same CDM group, and (ii) a second entry having a selection of one legacy DMRS port and one enhanced DMRS port from a same CDM group.

14. The apparatus of claim 3, wherein an eleventh table corresponds to a maximum length of 2 symbols and a rank of 4, wherein the entry comprises four DMRS ports, wherein the eleventh table comprises (i) a first entry having a selection of four enhanced DMRS ports from a same CDM group, (ii) a second entry having a selection of two legacy DMRS ports and two enhanced DMRS port from a same CDM group, iii) a third entry having a selection of two legacy DMRS ports from a first CDM group and two enhanced DMRS port from a second CDM group.

15. The apparatus of claim 3, wherein a twelfth table corresponds to a maximum length of 2 symbols and a rank of 5, wherein the entry comprises five DMRS ports, wherein the twelfth table comprises (i) a first entry having a selection of three legacy DMRS ports from a first CDM group and two legacy DMRS ports from a second CDM group, (ii) a second entry having a selection of four legacy DMRS ports from a first CDM group and one legacy DMRS port from a second CDM group, (iii) a third entry having a selection of two legacy DMRS ports from a first CDM group, two legacy DMRS ports from a second CDM group and one legacy DMRS port from a third CDM group, (iv) a fourth entry having a selection of three enhanced DMRS ports from a first CDM group and two enhanced DMRS ports from a second CDM group, v) a fifth entry having a selection of four enhanced DMRS ports from a first CDM group and one enhanced DMRS port from a second CDM group, vi) a sixth entry having a selection of four legacy DMRS ports and one enhanced DMRS port from a same CDM group, vii) a seventh entry having a selection of four enhanced DMRS ports and one legacy DMRS port from a same CDM group, viii) an eighth entry having a selection of four enhanced DMRS ports from a first CDM group and one legacy DMRS port from a second CDM group, and ix) a ninth entry having a selection of four legacy DMRS ports from a first CDM group and one enhanced DMRS port from a second CDM group.

16. The apparatus of claim 3, wherein a thirteenth table corresponds to a maximum length of 2 symbols and a rank of 6, wherein the entry comprises six DMRS ports, wherein the thirteenth table comprises (i) a first entry having a selection of three legacy DMRS ports from a first CDM group and three legacy DMRS ports from a second CDM group, (ii) a second entry having a selection of two legacy DMRS ports from a first CDM group, two legacy DMRS ports from a second CDM group, and two legacy DMRS ports from a third CDM group (iii) a third entry having a selection of three enhanced DMRS ports from a first CDM group and three enhanced DMRS ports from a second CDM group, (iv) a fourth entry having a selection of two enhanced DMRS ports from a first CDM group, two enhanced DMRS ports from a second CDM group, and two enhanced DMRS ports from a third CDM group, (v) a fifth entry having a selection of four legacy DMRS ports and two enhanced DMRS ports from a same CDM group, (vi) a sixth entry having a selection of two legacy DMRS ports and four enhanced DMRS ports from a same CDM group, (vii) a seventh entry having a selection of four legacy DMRS ports from a first CDM group and two enhanced DMRS ports from a second CDM group, and (vii) a seventh entry having a selection of two legacy DMRS ports from a first CDM group and four enhanced DMRS ports from a second CDM group.

17. The apparatus of claim 3, wherein a fourteenth table corresponds to a maximum length of 2 symbols and a rank of 7, wherein the entry comprises seven DMRS ports, wherein the fourteenth table comprises (i) a first entry having a selection of four legacy DMRS ports from a first CDM group and three legacy DMRS ports from a second CDM group, (ii) a second entry having a selection of four enhanced DMRS ports from a first CDM group and three enhanced DMRS ports from a second CDM group, (iii) a third entry having a selection of four legacy DMRS ports and three enhanced DMRS ports from a same CDM group, (iv) a fourth entry having a selection of three legacy DMRS ports and four enhanced DMRS ports from a same CDM group, (v) a fifth entry having a selection of four legacy DMRS ports from a first CDM group and three enhanced DMRS ports from a second CDM group, and (vi) a sixth entry having a selection of three legacy DMRS ports from a first CDM group and four enhanced DMRS ports from a second CDM group.

18. The apparatus of claim 3, wherein a fifteenth table corresponds to a maximum length of 2 symbols and a rank of 8, wherein the entry comprises eight DMRS ports, wherein the fifteenth table comprises (i) a first entry having a selection of four legacy DMRS ports from a first CDM group and four legacy DMRS ports from a second CDM group, (ii) a second entry having a selection of four enhanced DMRS ports from a first CDM group and four enhanced DMRS ports from a second CDM group, (iii) a third entry having a selection of four legacy DMRS ports and four enhanced DMRS ports from a same CDM group, and (iv) a fourth entry having a selection of two legacy DMRS ports from a first CDM group, two legacy DMRS ports from a second CDM group and four enhanced DMRS ports from the first CDM group, and (v) a fifth entry having a selection of four legacy DMRS ports from a first CDM group and four enhanced DMRS ports from a second CDM group.

19. An apparatus comprising processing circuitry configured to:
generate, for transmission to a user equipment (UE), one or more messages comprising a plurality of tables, wherein each table comprises one or more entries related to a selection of demodulation reference signal (DMRS) ports for a Physical Uplink Shared Channel (PUSCH);
generate, for transmission to the UE, a DMRS type 2 configuration for the PUSCH; and
process, based on signals received from the UE, the PUSCH comprising DMRS type 2 on the DMRS ports corresponding to the entry, wherein the DMRS ports are at least one of (i) legacy ports or (ii) enhanced ports.

20. The apparatus of claim 19, wherein the entry comprises all legacy ports, all enhanced ports or a combination of enhanced ports and legacy ports.
